(19) United States
(12) Patent Application Publication
(10) Pub. No.: US 2006/0155635 A1
(43) Pub. Date: Jul. 13, 2006

(54) Distributed trade match service

(75) Inventors: Todd Borro, Chicago, IL (US); Paul Waters, Chicago, IL (US)

Correspondence Address: BANNER & WITCOFF, LTD., TEN SOUTH WACKER DRIVE, SUITE 3000, CHICAGO, IL, 60606, US

(73) Assignee: Chicago Mercantile Exchange, Inc., Chicago, IL (US)

(21) Appl. No.: 11/144,167

(22) Filed: Jun. 3, 2005

Related U.S. Application Data
(60) Provisional application No. 60/643,189, filed on Jan. 12, 2005.

(51) Int. Cl. G06Q 40/00

(52) U.S. Cl. 705/37

(57) ABSTRACT

Financial instrument trade systems and methods are disclosed. Trade data is processed at a plurality of match servers. Trade data that remains unmatched may be stored in one or more aging queues. Trade data is periodically retrieved from the aging queues and attempts are made to match the unmatched trades. As time progresses from the time that trade data from a particular trade is stored in an aging queue, the match criteria used to match the trade is relaxed. Fault tolerant mechanisms are also disclosed for allowing operational match servers to take over the operations of failed components or servers.

The present application claims the benefit of U.S. provisional patent application No. 60/643,189, filed Jan. 12, 2005 and entitled “Distributed Trade Match Service,” the entire disclosure of which is hereby incorporated by reference.

### FIELD OF THE INVENTION

The present invention relates exchange clearing systems and methods. More particularly, the invention relates to exchange clearing systems and methods that include a distributed trade match service.

### DESCRIPTION OF THE RELATED ART

It is common for exchanges and other entities that perform trade clearing functions to use computer devices to match trades. For example, two traders may document trade data on separate cards. The trade data may then be entered into a computer system that is configured to match the trades. Typical computer systems utilize a monolithic clearing application that steps through a predetermined process in order to match outstanding unmatched trades. For example, the clearing application may seek to match all trades having common match critical fields. Match critical fields may include the identification of executing brokers, contracts, price and other information used to identify a specific trade.

Existing monolithic clearing applications can be difficult to modify and expand. For example, when it is necessary to match new types of trades, extensive modifications to large segments of the application are required. Moreover, the monolithic structure of such applications limits scalability because of the number of modifications that are required when adding new features.

Another limitation of existing trade clearing systems and methods is that they are designed to operate in “batch” modes. Unmatched trades are periodically analyzed and a procedure is undertaken to match the unmatched trades. The criteria used to match unmatched trades is progressively relaxed for all unmatched trades as time progresses. This batch process treats all unmatched trades the same, regardless of how long each trade has been unmatched. Moreover, inefficient utilization of resources results from extensive processing resources being consumed while the batch processes are executed and no processing resources being consumed at times between the execution of the batch processes.

Therefore, there is a need in the art for more scalable and efficient trade matching systems and methods.

### SUMMARY OF THE INVENTION

Aspects of the present invention overcome problems and limitations of the prior art by providing distributed trade matching systems and methods. A plurality of servers work together to match trades. In one embodiment, all trade data is stored at each server. In another embodiment, trade data may be assigned to specific servers to divide the workload of matching trades. Trade data that remains unmatched may be stored in one or more aging queues. Trade data is periodically retrieved from the aging queues and attempts are made to match the unmatched trades. As time progresses from the time that trade data from a particular trade is stored in an aging queue, the match criteria used to match the trade is relaxed.

In certain embodiments of the invention, the disclosed clearing systems and methods may be used to clear futures and options trades.

In other embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 illustrates a computer network system that may be used to implement aspects of the present invention.

FIG. 2 illustrates a distributed trade match system, in accordance with an embodiment of the invention.

FIG. 3 illustrates a method of matching trades in accordance with an embodiment of the invention.

FIG. 4 illustrates a fault tolerant method of operating match servers in accordance with an embodiment of the invention.

### DETAILED DESCRIPTION OF THE INVENTION

Exemplary Operating Environment

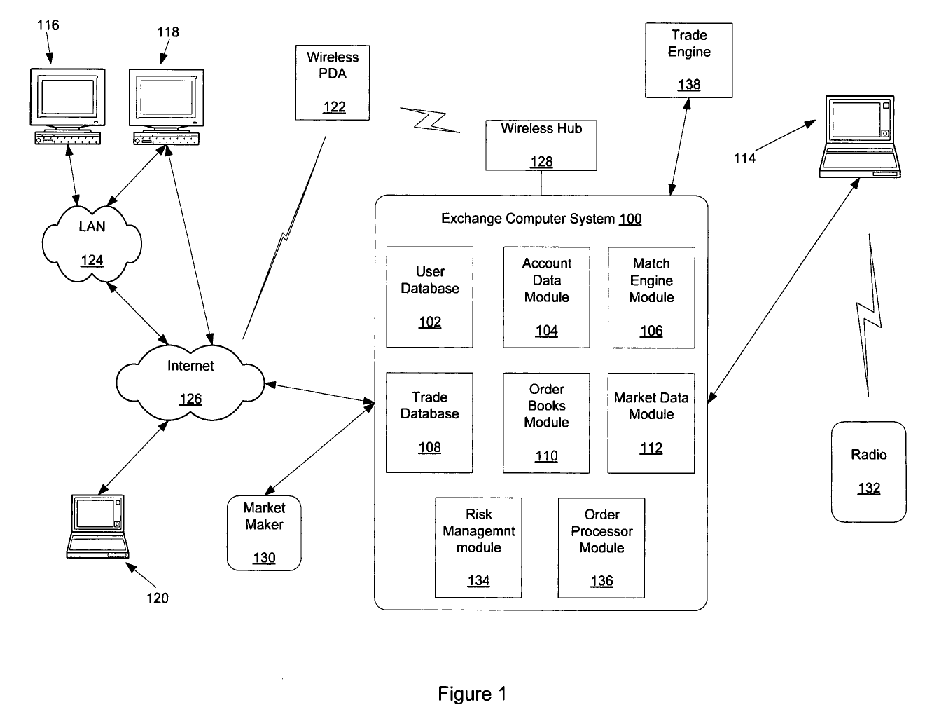

Aspects of the present invention are preferably implemented with or used in conjunction with computer devices and computer networks. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.)

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

Exemplary Embodiments

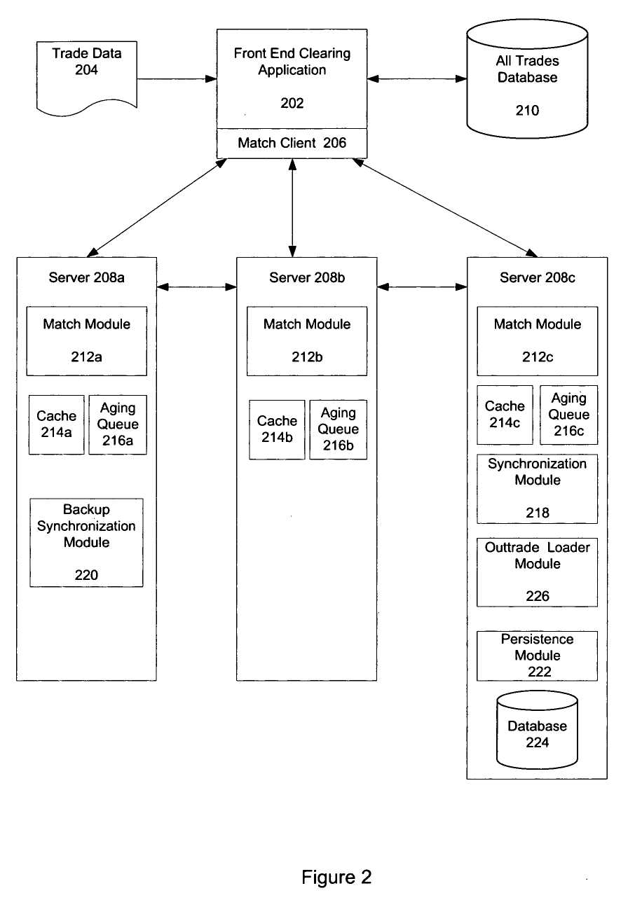

FIG. 2 illustrates a distributed trade match system in accordance with an embodiment of the invention. A front end clearing application 202 receives trade data 204. Trade data 204 may include information that identifies a trade, such as the identification of executing brokers, contracts, price and quantity. A match client 206 may contain application program interfaces and/or other software modules that allow front end clearing application 202 to communicate with a plurality of match servers 208a-208c. A variety of different match clients may be used to allow different front end clearing applications to communicate with match severs. For example, a first front end clearing application may use a first match client to communicate with a set of match severs and a second front end clearing application may use a second match client to communicate with the same set of match severs. Front end clearing application 202 is also coupled to an all trades database 210. All trades database 210 contains a master record of all trades that have taken place.

The embodiment shown in FIG. 2 includes three match servers 208a-208c. Servers 208a-208c may be in the same location or may be geographically distributed. Three servers are shown for illustration purposes only and with the understanding that aspects of the invention may use more or fewer servers. Match servers 208a-208c may each be connected to one another, connected through a common hub or connected in another manner that allows each match server to communicate with the remaining match servers.

Servers 208a-208c contain modules for matching trades, such as trades executed at an exchange. Server 208a includes a match module 212a that may be implemented with a software application that matches unmatched trades. Match module 212a may include or be linked to a set of rules for matching trades. The rules for matching trades may identify specific match criteria used for matching specific trades. As described in detail below, a match module may use several different match criteria and the match criteria selected may be a function of the length of time that trade data has remained unmatched.

Match criteria may refer to match critical fields such as: firm, firm number, broker number, quantities, executing brokers and time brackets. In some embodiments of the invention certain match criteria must be exact and are never relaxed. Such criteria may include price, contract and the identification of an exchange.

In addition to performing one-to-one matches, match module 208a may be programmed to match one-to-many trades and/or many-to-many trades. Match module 202 may also find subsets of trades that match. One or more match modules may use multiple threads when matching trades.

Servers 208b and 208c may include match modules 212b and 212c that are similar to match module 212a. In one embodiment of the invention match modules may be used to match specific types of trades or trades that take place in specific locations. For example, match module 212a may be configured to match trades that were executed at one exchange and match module 212b may be used to match trades that were executed at another exchange.

Trade data is initially received from front end clearing application 202 and stored in caches 214a-214b. In one embodiment of the invention each cache contains all trade data. In another embodiment of the invention trade data is distributed among caches 214a-214c. Match modules 212a-212c communicate with one another as trades are matched so that a match module does not expend resources attempting to match a trade that has already been matched.

In one embodiment of the invention, match modules 212a-212c and/or caches 214a-214c communicate using the Java Messaging Service standard publish and subscribe application program interface (API). The type of information that may be exchanged includes information to add, update and remove trade data from caches 214a-214c. In one implementation, only information identifying changes in the state of caches 214a-214c is exchanged, as opposed to information identifying the entire state of a cache.

Some or all messages exchanged between servers 202a-202c may also be sent to a synchronization module 218 so that synchronization module 218 may maintain the states of the components of each server. Synchronization module 218 may exchange messages with match modules 212a-212c, caches 214a-214c and/or aging queues 2162a-216c to determine the state of such components. In the event of a failure of one of servers 208a-208c or critical components, synchronization module 218 may inform another server or component of what data to obtain from a persistence module 222 that may store all of the data used by servers 208a-208c. For example, if server 208a fails, synchronization module 218 may identify the trade data that was stored in cache 214a and aging queue 216a and instruct server 208b to obtain the data from persistence module 222 to load into cache 214b and aging queue 216b. Persistence module 222 may store data in a database 224.

Servers 208a-208c may also include aging queues 216a-216c. Each aging queue may contain trade data that has not been matched. Each aging queue may contain a unique subset of unmatched trade data so that the workload is distributed across servers. Each trade may be aged individually such that match criteria is relaxed as time goes on for element of trade data. For example, match module 212a may be configured to relax match criteria and reattempt to match trade data after data has been store in aging queue 216a for one hour. With prior art match systems, trade data is treated in a batch manner and match criteria is relaxed the same amount for all unmatched trades at a given time. Aging trades separately, provides for a more efficient match system. Moreover, several additional levels of match criteria may be used. For example, instead of a match module running batch processes twice a day with different levels of match criteria, the match module may make 10 or more match attempts using different match levels of match criteria.

Synchronization module 218 may ensure that only a single a match module 212a-212c has permission to match trade data at any point in time. In one embodiment, unmatched trade data stored in caches 214a-214c includes a data structure or other mechanism that allows synchronization module 218 to lock the state of the trade while a match module attempts to match the trade. For example, if match module 212a attempts to match trade data for a specific trade, synchronization module 218 will lock the copy of the trade data stored in caches 214b and 214c so that two match modules do not match the same trade.

Synchronization module 218 may also be configured to control access to trade data stored in aging queues 216a-216c. Synchronization module 218 and/or aging queues 216a-216c may be configured to add delays to the age of trade data when a potential collision exists. For example, match module 212a may try to match trade data stored in aging queue 216a with trade data stored in aging queue 216c and determine that the trade data stored in aging queue 216c has been locked by synchronization module 218. If the trade would have been matched if not for the locked state of the trade data, a random or predetermined delay may be added to each element of trade data to reduce the likelihood of a collision the next time that a match is attempted. In one embodiment of the invention, each aging queue assigns a unique delay to reduce the likelihood of collision during subsequent match attempts.

The system illustrated in FIG. 2 includes a backup synchronization module 220 in server 208a. Backup synchronization module 220 may be configured to operate in place of synchronization module 218 in the event of failure of synchronization module 218 or server 208c. The system illustrated in FIG. 2 may additional redundancy to ensure proper operation when one or more components fail.

In one embodiment of the invention, each synchronization module or persistence module may receive periodic messages from each match module 202a-202c which indicate that the match module is operational. When an expected message is not received, data may be retrieved from database 224 and transmitted to another match module to continue operations in place of the failed match module.

An outtrade loader module 226 may synchronize the contents of all trades database 210 and database 224. Synchronization may be necessary, for example, when front end clearing application 202 removes trade data from all trades database 210. Synchronization may occur at periodic intervals, such as weekly during non-trading times.

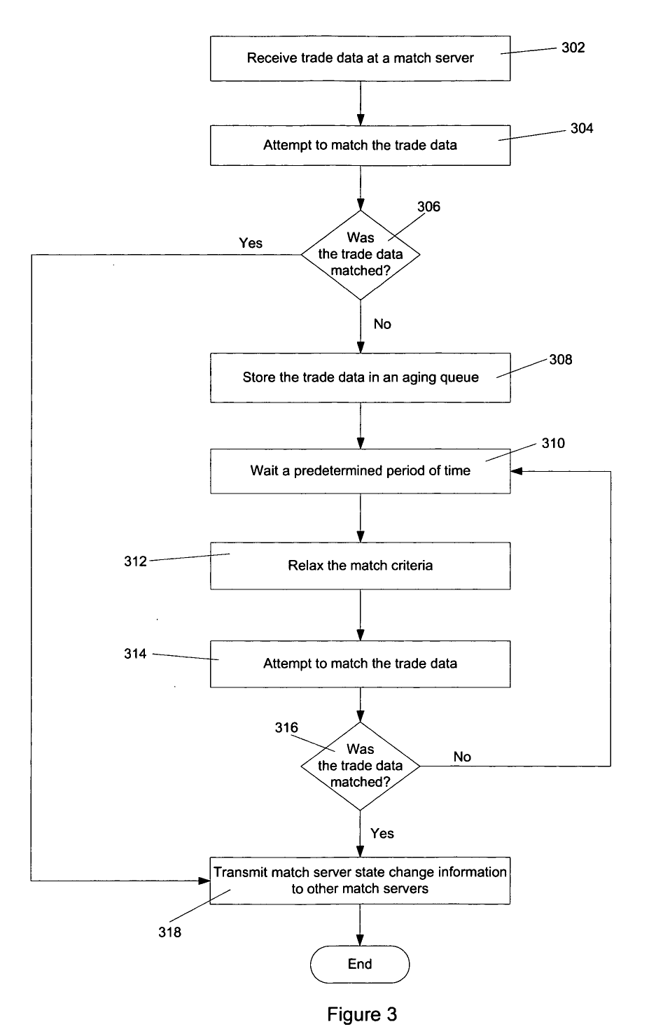

FIG. 3 illustrates a method of matching trades in accordance with an embodiment of the invention. In step 302 trade data is received at a match server. As indicated above, trade data may include information that identifies a trade, such as the identification of an executing broker, contract, price and quantity. In step 304 an attempt is made to match the trade data. Step 304 may be performed at a match module, such as match module 212a and may include attempting to match the trade data from one side of a trade to trade data from another side of the same trade.

Next, in step 306 it is determined whether the trade data was matched. When the trade data is matched, the process proceeds to step 318, which is described below. When the trade data has not been matched, in step 308 the trade data is stored in an aging queue. The trade data is stored in the aging queue for a predetermined period of time in step 310 before the match criteria is relaxed in step 312. As used herein a “predetermined time period” is meant to encompass a time period that results in trade data aging individually. For example, a predetermined time period may be a fixed time interval, such as 1 hour, or fixed interval that is determined by the load on a match server. A “predetermined time period” does not include a time interval that ends when all trade data is acted on in a batch process.

Storing the trade data in the aging queue for a predetermined period of time allows for the processing of the other side of the trade and increases the likelihood that a match will be found on the next attempt. After the match criteria has been relaxed, in step 314 another attempt is made to match the trade data. One skilled in the art will appreciate that step 312 may include eliminating one or more match criteria, requiring a less strict match between match criteria or any other change that makes it more likely that trade data from opposite sides of a transaction will match. For example, if step 304 includes attempting to find an identical match between firm number, broker number, quantity and contract, step 312 may include eliminating the broker number fields and step 314 may include attempting to find an identical match between firm number, quantity and contract.

In step 316 it is again determined whether the trade data was matched. When the trade data has been matched, the match server may transmit state change information to other match servers in step 318. Step 318 allows other match servers to stop any attempts to match the trade data that has been matched.

When trade data is not matched in step 316, the process returns to step 310 and after a predetermined time period, the match criteria is relaxed again and another attempt is made to match the trade data.

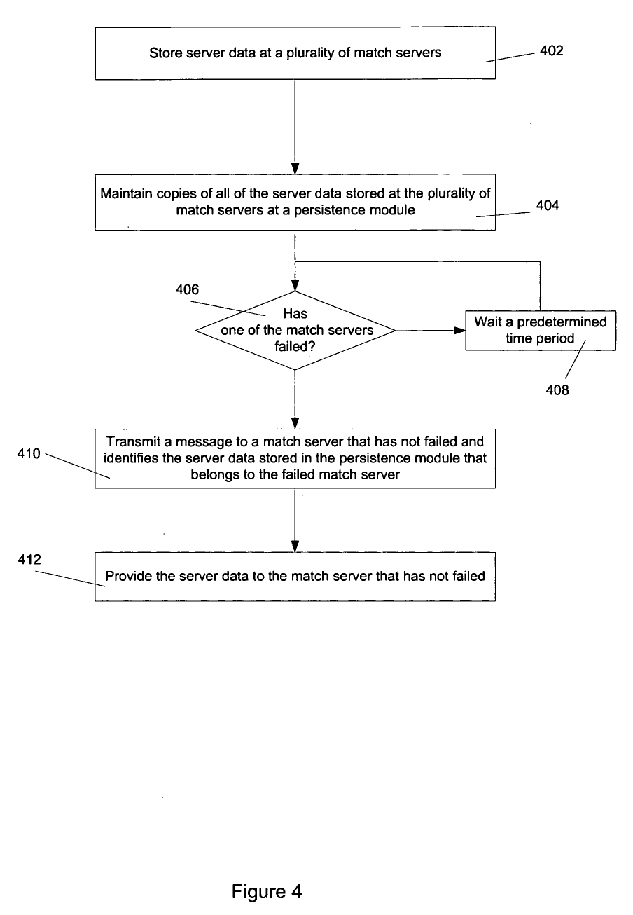

FIG. 4 illustrates a fault tolerant method of operating match servers in accordance with an embodiment of the invention. In step 402 server data is stored at a plurality of match servers. A persistence module maintains copies of all of the server data stored at the plurality of match servers in step 404. As new data arrives at a match server or is produced at a match server, the server data is transmitted to and stored in a persistence module. In step 406 it is determined whether a match server has failed. Step 406 may include analyzing match server test results. When it is determined that a match server has not failed, in step 408 the process waits a predetermined time period in step 408 before checking the status of match servers again. In an alternative embodiment, match servers may periodically transmit status messages to a synchronization module, such as synchronization module 218, and the synchronization module may determine that a component of or an entire match server has failed based on the contents of the message or the absence of the message.

In step 410, a synchronization module or other component may transmit a message to a match server that has not failed and identifies the server data stored in the persistence module that belongs to the failed match server or component. Finally, in step 412 the server data is provided to the match server that has not failed. Of course, steps 410 and 412 may be modified so that two or more operational match servers take over the processing operations of a failed server. In one alternative embodiment, a synchronization module may directly transmit server data to an operational match server.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method of matching trade data at an exchange, the method comprising:
(a) receiving trade data at a match server;
(b) attempting to match the trade data with data from an opposite side of a trade by applying a first match criteria that identifies a set of match critical fields that must match for a match to be declared;
(c) when the trade data remains unmatched after (b), storing the trade data in an aging queue;
(d) at a first predetermined time after storing the trade data in the aging queue, attempting to match the trade data with data from the opposite side of a trade by applying a second match criteria that identifies a set of match critical fields that must match for a match to be declared; and
wherein the second match criteria is less stringent than the first match criteria.

2. The method of claim 1, wherein the second match criteria includes matching fewer match critical fields than the first match criteria includes.

3. The method of claim 1, further including:
(e) when the trade data remains unmatched after (d), at a second predetermined time after (d), attempting to match the trade data with data from the opposite side of a trade by applying a third match criteria that identifies a set of match critical fields that must match for a match to be declared; and
wherein the third match criteria is less stringent than the second match criteria.

4. A method of matching trade data, the method comprising:
(a) applying a first match criteria to attempt to match trade data with data from an opposite side of a trade;
(b) when the trade data remains unmatched after (a), storing the trade data in an aging queue; and
(c) at a first predetermined time after storing the trade data in the aging queue, applying a second match criteria to attempt to match the trade data;
wherein the second match criteria is less stringent than the first match criteria.

5. The method of claim 4, wherein the second match criteria includes matching fewer match critical fields than the first match criteria includes.

6. The method of claim 4, wherein the first match criteria includes matching match critical fields that include executing broker, contract, price and a time bracket.

7. The method of claim 4, further including:
(d) when the trade data remains unmatched after (c), at a second predetermined time after (c), applying a third match criteria to attempt to match the trade data;
wherein the third match criteria is less stringent than the second match criteria.

8. The method of claim 7, wherein the first, second and third match criteria include price and contract match critical fields.

9. The method of claim 4, wherein the opposite side of a trade in (a) comprises multiple trades.

10. A method of operating a trade matching system, the method comprising:
(a) storing server data at a plurality of match servers and at a persistence module;
(b) determining when one of the plurality of match servers fails;
(c) when one of the plurality of match servers fails, identifying the server data stored on the failed match server; and
(d) providing the server data identified in (c) to at least one operational match server.

11. The method of claim 10, wherein (b) comprises determining when a component of a match server fails and the server data comprises data used by the component.

12. The method of claim 10, wherein (b) comprises analyzing match server test results.

13. The method of claim 10, wherein (b) comprises determine that an expected messages was not received.

14. The method of claim 10, wherein (b) comprises analyzing a received message.

15. The method of claim 10, wherein (d) comprises retrieving the server data from the persistence module and transmitting the server data to the at least one operational match server.

16. The method of claim 10, wherein (d) comprises providing the server data identified in (c) to at least two operational match servers.

17. A system for matching trade data, the system comprising:
a first match server configured to match trade data from a first type of trade;
a second match server configured to match trade data from a second type of trade;
a match client coupled to the first match server and the second match server and configured to route trade data to the first match server and the second match server; and
a synchronization module that maintains the states of components of the first match server and the second match server.

18. The system of claim 17, wherein the first and second match servers include aging queues that individually age unmatched trade data between attempts to match the trade data.

19. The system of claim 17, wherein the first and second match servers are geographically distributed.

20. The system of claim 19, wherein the first and second match servers are located at different exchanges.
